(19) United States
(12) Patent Application Publication
(10) Pub. No.: US 2021/0274591 A1
(43) Pub. Date: Sep. 2, 2021

(54) CRITICAL INCIDENT SAFETY AND SECURITY NOTIFICATION SYSTEM

(71) Applicant: Paul J. Norcross, High Point, NC (US)

(72) Inventor: Paul J. Norcross, High Point, NC (US)

(21) Appl. No.: 16/805,980

(22) Filed: Mar. 2, 2020

(51) Int. Cl. H04W 76/50; H04W 4/90; H04H 20/59; G08B 25/14; G08B 5/38; G08B 7/06; G07C 9/00; G08B 27/00

(52) U.S. Cl. CPC H04W 76/50; H04W 4/90; H04H 20/59; G08B 25/14; G07C 2009/00515; G08B 7/06; G07C 9/00309; G08B 27/005; G08B 5/38

(57) ABSTRACT

The present invention relates to a critical incident safety and security notification system for a building wherein upon the occurrence of a critical incident, the activation system signals a plurality of other safety and security systems to initiate, including the engagement of door barricades and informational and instructional notifications in the form of lighting, audio, text, and/or email being sent to the occupants of a building. Simultaneously, this notification system sends messages to law enforcement and first responders on a connected, web based platform and includes an integrated computer mapping system for critical incident location reporting. In one embodiment, a particular area of lighting in the building can be caused to strobe in order to disorient a shooter or other unwanted intruder, or to indicate the critical incident location.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system for notification of a critical incident to individuals in a commercial building for the safety of its occupants. In particular, it relates to a system for alerting people in a building by initiating an action alert and safety system within the building and instant notification to first responders.

### Description of Related Art

The incidence of a critical incident in a building, such as an active shooter or active intruder, demands that the occupants of the building be notified as to what is going on. Depending on the critical situation, different solutions may need to be taken by the occupants of the building. For example, they may need to leave the building, find shelter, barricade the door to the room they are in, and the like, depending on the situation.

Fire alarms, fire flashing lights, and the like are frequently used when there is a fire or tornado. However, in a busy building, like a school for example, the noise level combined with an alarm makes it impossible to hear any announcements connected with the critical incident. This can result in confusion and people getting hurt. Where one alarm is used for all critical incidents, the occupants of the building, such as students, are left confused as to what to do next and this can lead to injury or even death under those circumstances. There are many auxiliary services associated with critical incidents, such as shot detection technology, but there is no way to ensure that the occupants are informed.

### BRIEF SUMMARY OF THE INVENTION

The present invention relates to utilizing the critical incident system, coupled with multiple, simultaneous methods of alerting building occupants including an audible alert of a horn plus strobe, computer mapping, text alert, and email alerts (which provide instant, actionable data to building occupants in order to know how to respond). The shot detection system provides connectivity to emergency response services advising of a critical incident, and mapping indicators reflect which rooms have been secured. The messaging system sends messages back to first responders on a connected, web based platform. In addition to the core system, additional systems can be linked to core systems such as access controls, VOIP systems, and building lighting.

Accordingly, in one embodiment, there is a building safety and security notification system for use during a critical incident in a building, or multiple buildings in a campus, or interfaced network, the system comprising:
a) an activation system which is activated by the occurrence of the critical incident and when activated, the rest of the building safety and security notification system engages;
b) mapping system showing the location of the critical incident;
c) a building announcement system; and
d) an automatic unlocking of a plurality of exterior building doors.

In another embodiment, there is a method for notifying occupants of a building of a critical incident, the method comprising:
a) activating an activation system in response to the critical incident which initiates the notification to occupants of the critical incident;
b) engaging a mapping system to locate the critical incident;
c) activating a building announcement system in response to the activation system initiation; and
d) an automatic unlocking of a plurality of exterior building doors.

### BRIEF DESCRIPTION OF THE DRAWINGS

FIG. 1 is a diagram of the parts of the system of the present invention.

FIG. 2 is a flow chart of the method of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein; are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “lighting” refers to the lighting in a commercial building such as a school, office; warehouse; and the like. It includes ceiling lighting and any lighting designed to light a large area, as opposed to task lighting. It includes standard commercial lighting such as incandescent lights, LED lights, and fluorescent lights. It also includes emergency lighting strobes. Where the lighting is to be dimmed, the bulbs of the lighting must be the dimmable type of lamps. All such lighting could be subject to dimming or a portion of lighting could be dimmed. For example, only the lamps in the hallway or certain parts of the building would be set to dim. In one case, the area to be dimmed is selectable. Where there is an active shooter or intruder, one embodiment of the invention has the lighting strobing in the vicinity of the shooter or intruder, while the remaining lights dim. It can be different or the same depending on the critical incident being covered. In addition, colored, blinking lights could be used and in one embodiment, the blinking indicates Run, Hide, Barricade in a room, etc.

As used herein, the term “critical incident” refers to some sort of dangerous event that the occupants of the building should know about and take appropriate action for. So for instance, an active shooter in the building, an intruder, a tornado, a fire, or anything emergency of this kind would be included. In general, these are events in which case it is best if the occupants know what is happening and have coordinated information for what to do, e.g., take shelter, leave the building, engage door locks or barricade, and the like.

As used herein, the term “light intensity control system” refers to an electronic device, software residing in a computer, or the like which, when activated by the appropriate signal from an activation module, dims at least a portion of the lighting to between about 5% and 30% of full bulb intensity prior to the dimming, but circumstances of the critical incident will determine what works best. A strobing or blinking light can also be activated. This is followed by an announcement from the building announcement system. It is activated by the activation system being engaged.

As used herein, the term “mapping system” refers to demographic data, maps, and the like designed to discover the location of the critical incident. In one embodiment, a shot detection system is used to indicate location.

As used herein, the term “activation system” refers to a device, sensor, or the like which is activated by the occurrence of the critical incident and activates the building safety and security notification system. Some examples of an activation system action include, but are not limited to, a shot detector, a button sending the signal, a panic button, a call in the building to emergency services, a fire alarm, and the like.

As used herein, the term “building announcement system” refers to a public address system located around the building such that all occupants of the building can hear the announcement initiated by the activation system. The building announcement system will either have live or recorded information about the critical incident and what to do. So for example, if there is an active shooter, the announcement might say “shooter detected-all occupants return to a room and lock the door.” It could also include strobe lights, a horn, or the like. The activation system, in one embodiment, is activated by a shot detection system.

As used herein, an “instructional illumination system” refers to the activation system engaging one or more lights which are designed to inform and instruct individuals of the critical incident when turned on. For example, strobing lights, color lights, spot lights, and the like. In one embodiment, the instructional illumination system comprises three lights of different colors, wherein each one indicates a different activity.

As used herein, the term “door barricade” refers to systems that are available to prevent entry into a particular room, such as a classroom. They are engaged from the inside of the door with no means for an active shooter, intruder, or the like to be able to open the door from the outside. The door barricade can be manually or automatically engaged based on a signal from the safety and security notification system. In another embodiment, the door barricade sends a signal to the safety and security notification system that the door barricade has been engaged. This is especially useful for manual engagement of such a system. In another embodiment, the door barricade being deployed could cause a video camera in the barricaded room to be activated including both live and/or recorded footage. In yet another embodiment, a notification system such as a text, a phone call, and/or an email could be automatically sent out to designated individuals or groups.

As used herein, the term “shot detection system” refers to devices which can sense if a gun has been discharged, and if so, send an appropriate signal to the safety and security notification system to engage. In this case, the shot detector could also act as the activation system and the location detector. These can be off the shelf systems or a particular one designed specifically to be used in the safety and security notifications system.

As used herein, the term “notification system for sending texts, phone calls, and/or emails” refers to a device or software which, when activated by the critical incident, sends these messages to occupants of the building, law enforcement, emergency first responders, etc. to give them specific details in writing or by voice.

As used herein, the term “video feed system” refers to having video cameras around the building which are activated when the activation system sends a signal. The cameras can send video to the appropriate authorities, e.g., school officials, law enforcement, and the like.

As used herein, the term “automatic messaging system” refers to a pre-recorded message which is played over the PA system to give information to the occupants of the building. It can also refer to turning on a PA system to allow an individual to give an announcement, live or pre-recorded.

As used herein, the term “system which causes the lights to strobe” refers to the use of strobing lights to disorient a shooter or intruder, or to indicate a critical incident. So upon the critical incident, most of the lights may be dimmed and the lights in the vicinity of the shooter or intruder start to strobe, causing disorientation. The strobing would, in one embodiment, only be in the area of the critical incident. Other systems may be utilized including using impact resistant glass and security and fire monitoring. A mapping system can also be used to locate a critical incident.

### DRAWINGS

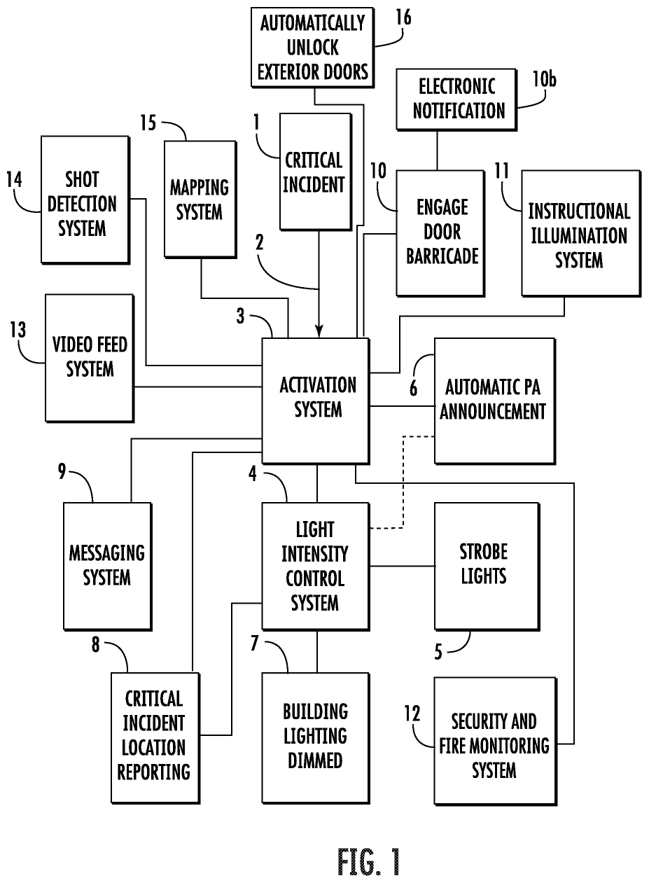

Now referring to the drawings, FIG. 1 is a diagram of the system of the present invention. Upon the occurrence of a critical incident 1, a signal 2, either manual or automatic, is sent to activation system 3 in order to activate a number of actions including the light intensity control system 4 and in some embodiments, causing the lights in an area to strobe 5. An automatic PA announcement 6 is also activated. The building lights are dimmed 7, as described herein. As shown, a number of other things can happen once the activation system 3 is activated. For example, a critical incident location reporting 8, a messaging system 9, and a video feed system 13 can be activated, a signal to engage the door barricade 10, and/or an electronic notification signal 10b can be sent to a central location. In addition, the door barricade 10 could be automatically engaged and instructional illumination system 11 could be utilized, especially depending on the exact critical incident. Also, security and fire monitoring 12 can be included. A shot detection system 14 can also be used to trigger the system or used to determine location. A mapping system 15 can also be used to locate a critical incident. In addition, a plurality of exterior building doors are automatically unlocked 16.

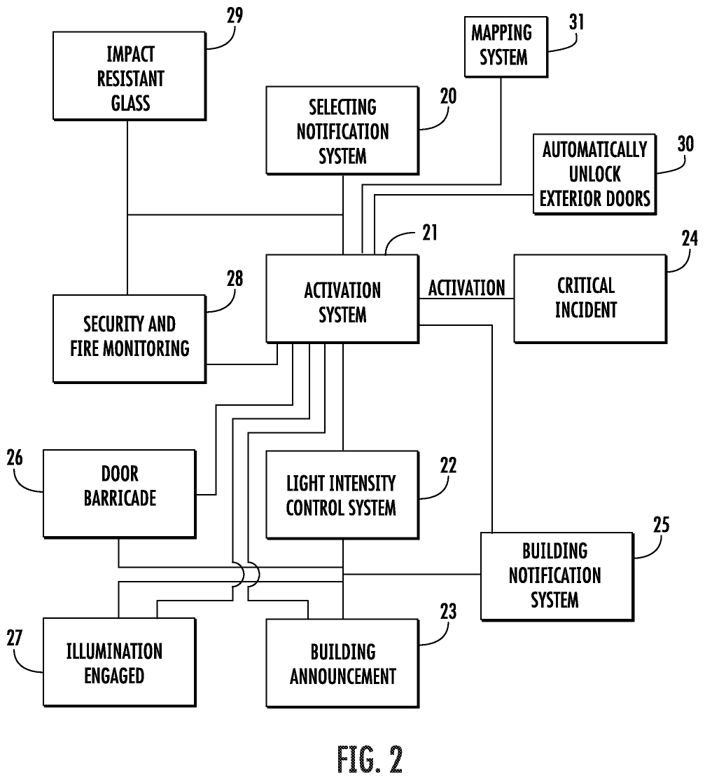

In FIG. 2, a flow chart of the method of the present invention is listed. A notification system is selected (and installed) 20 in a building. Upon the occurrence of a critical incident 24, an activation system 21 sends a signal engaging all the other systems (from FIG. 1), as necessary. The signal is sent to the light intensity control system 22 to lower the lighting, i.e.; modulation and/or activate strobe lighting. Once the lights are dimmed, a building announcement 23 is made along with optional building notification system 25 which handles notifications such as incident location, messaging, and locking of building doors (door barricade) 26, engaging illumination 27, and the like. Also shown are security and fire monitoring 28 and a prior action of glass replacement with impact resistant glass 29. The mapping system 31 indicates the location of the incident in the building. Further, a plurality of exterior building doors are automatically unlocked 30 to allow entry of first responders and emergency services.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A building safety and security notification system for use during a critical incident in a building, multiple buildings on a campus, or interfaced network, the system comprising:
a) an activation system which is activated by an occurrence of the critical incident and when activated, the rest of the building safety and security notification system engages;
b) a mapping system showing the location of the critical incident;
c) a building announcement system;
d) a plurality of exterior building doors which are automatically unlocked; and
e) an instructional illumination system activated by the activation system.

2. The building safety and security notification system according to claim 1, which is activated by one or more of a shot detection system, a panic button, a call to emergency services, and a fire alarm.

3. The building safety and security notification system according to claim 1, wherein the critical incident is at least one of an intruder, fire, earthquake, tornado, and a shooter firing.

4. The building safety and security notification system according to claim 1, which further comprises one or more door barricades to one or more rooms in the building.

5. The building safety and security notification system according to claim 4, wherein the door barricade further comprises one or more of an ability of sending information that the door barricade is engaged to a desired one or more recipients and the ability to engage a video camera in the room.

6. The building safety and security notification system according to claim 1, which further comprises at least one of:
a) a system for sending texts, phone calls, and emails;
b) a video feed system;
c) an automatic messaging system;
d) door barricade locking system;
e) a system which causes the lights to strobe in an area where a shot is detected;
f) impact resistant glass; and
g) security and fire monitoring.

7. The building safety and security notification system according to claim 6, wherein there is a system to announce where the shot(s) has been fired.

8. A method for notifying occupants of a building of a critical incident, the method comprising:
a) activating an activation system in response to the critical incident which initiates the notification to occupants of the critical incident;
b) engaging a mapping system to locate the critical incident;
c) activating a building announcement system in response to the activation system initiation;
d) automatically unlocking a plurality of exterior building doors; and
e) activating an instructional illumination system activated by the activation system.

9. The method for notifying occupants of a building of a critical incident according to claim 8, the method which further comprises at least one of:
a) a system for sending texts, phone calls, and emails;
b) a video feed system;
c) an automatic messaging system to external recipients;
d) door barricade locking system;
e) a system which causes the lights to strobe in an area where a shot is detected;
f) impact resistant glass; and
g) security and fire monitoring.

10. The building safety and security notification system according to claim 1, wherein the instructional illumination system activated by the activation system comprises at least one of strobing lights, spotlights, and lights of different colors.

11. The building safety and security notification system according to claim 10, wherein the strobing lights are positioned to disorient an intruder.
